(19) United States
(12) Patent Application Publication
(10) Pub. No.: US 2014/0111191 A1
(43) Pub. Date: Apr. 24, 2014

(54) "SENSOR ARRANGEMENT, SENSOR BEARING AND METHOD FOR PRODUCING A SENSOR ARRANGEMENT"

(71) Applicants: Christophe Andre, Scorbe-Clairvaux (FR); Florian Barcat, Tours (FR); Sylvain Chaussat, Tours (FR); Pierrick Maze, Tours (FR); Matthieu Rioteau, Ssint-Clement-des-Levees (FR)

(72) Inventors: Christophe Andre, Scorbe-Clairvaux (FR); Florian Barcat, Tours (FR); Sylvain Chaussat, Tours (FR); Pierrick Maze, Tours (FR); Matthieu Rioteau, Ssint-Clement-des-Levees (FR)

(21) Appl. No.: 14/111,189

(22) PCT Filed: Apr. 11, 2011
(86) PCT No.: PCT/IB11/01417

§ 371 Date: Dec. 19, 2013

(51) Int. Cl. G01B 7/14

(52) U.S. Cl. CPC G01B 7/14
USPC 324/207.2; 324/207.11; 324/207.13; 438/3

(57) ABSTRACT

The invention relates to a sensor arrangement for use in a sensor bearing with a magnetic ring (14) with multiple pole pairs, the sensor arrangement including at least three magnetic sensors (16) and to a sensor bearing using such a sensor arrangement.

It is proposed that the at least three magnetic sensors (16) are encapsulated in a prefabricated package (17).

### 1. TECHNICAL FIELD OF THE INVENTION

The invention relates to a sensor arrangement for use in a sensor bearing, a sensor bearing including such a sensor arrangement and method for producing a sensor arrangement.

### 2. BACKGROUND OF THE INVENTION

Bearing assemblies including sensors for measuring the absolute position of one of the bearing rings with respect to the other bearing ring are known e.g. from the document WO 2007/077389 A2. The system comprises three magnetic sensors delivering sinusoidal signals in response to a magnetic field generated by a magnetic encoder ring and a substraction module for processing the signals.

The active areas of Hall cells used in sensor bearings of the type described in WO 2007/077389 A2 need to be positioned very precisely relative to each other and relative to the pole surface of the magnetic multipolar encoder ring. Imprecision in the radial, axial or angular position of the active area of the Hall cells immediately affects the electric signal precision and therefore the precision of the position measurement.

Usually, each Hall effect cell or Hall sensor is encapsulated into an individual package and each of these packages is subjected to individual thermal stress. This often leads to having one of the cells more exposed to heating sources than others. This exposed cell is submitted to faster ageing leading to creation of a “weak” point in the product and reducing high operating temperature life. Detrimental heat sources may include external sources or internal sources. Further, differences in the heat dissipation from the sensor packages may lead to different temperatures and thus different life-times and differing characteristics and behaviours of the cells.

The conventional technology with individually encapsulated Hall cells suffers from various sources of imprecision since several dimensions and processes must be accounted for in order to obtain a desired overall precision. These factors include the die to package dimensions and tolerances, the package location tolerances and the assembly conditions.

The precise positioning of the sensor cells is a process which is very difficult to be automated since it requires individual handling of the cells, wherein the latter are manually inserted into recesses in a holder. The holder itself needs to have very small tolerances, which leads to increased costs.

Finally, this design does not offer homogeneous performance because different production batches of the Hall cells show different characteristics.

### 3. SUMMARY OF THE INVENTION

In order to solve the above problems, the invention proposes a sensor arrangement, a sensor bearing and a method for manufacturing a sensor arrangement according to the independent claims.

A sensor arrangement for use in a sensor bearing with a magnetic ring with multiple pole pairs may include at least three magnetic sensors and is in particular characterized by at least three magnetic sensors encapsulated in a prefabricated package.

The sensor arrangement may be used in any type of bearing, including ball bearings, cylinder bearings, roller bearings, needle bearings or plain bearings and the sensor arrangement may be fixed to the outer ring or to the inner ring thereof while the magnetic ring is fixed to the other ring respectively.

The magnetic ring includes preferably a ferromagnetic or permanent magnetic washer having regions being magnetized with alternating polarity. Solutions where each pole is constituted by an individual permanent magnet are possible as well. The magnetic ring may be fixed to the inner ring or to the outer ring of the bearing by means of a fixing flange, which may be snapped into a pertinent fixing groove in the ring of the bearing. Further, the magnetic ring may be combined with sealing rings of the bearing.

The magnetic sensors used in the invention are preferably “naked” semiconductor chips or dies without individual packages and without legs in order to minimize the size of the sensor arrangement. Each sensor comprises preferably only one active element or Hall cell.

The provision of at least three magnetic sensors, preferably an odd number of sensors, ensures a reliable and precise detection of the absolute position of the rotating ring, wherein the sensors are preferably homogeneously distributed over one pitch angle of the magnetic ring, i.e. the angle between the centres of two subsequent poles with the same polarity. The number of sensors per pole pair may be increased e.g. to 5 when an increased precision is needed.

In a preferred embodiment of the invention, the at least three magnetic sensors are Hall sensors. The Hall sensors may be connected as current cells or alternatively the Hall sensors are connected and used as voltage cells. The latter alternative may help to reduce the number of input/output pins required. In any of these cases, the Hall sensors are preferably analog linear Hall dies configured for sensing a sine-shaped magnetic field distribution generated by the magnetic ring. The phase angle of the ring may be determined from the analog output of the Hall sensors.

Alternative embodiments of the invention may use GMR sensors or latching Hall sensors for sensing the magnetic field.

According to a further aspect of the invention, it is proposed that semiconductor chips constituting the magnetic sensors are directly mounted on a printed circuit board using the chip-on-board technology. Alternatively, a flip-chip technology, or a wire bonding may be used. When using flip-chip bonding, the dimensions of the sensor arrangement may be further decreased.

By directly bonding the dies of the magnetic sensors onto the output pins, the thermal transport from the dies may be improved. The package has preferably one single layout of output/input pins. The pin number is equal to number of dies+2 (power supply and ground) for an analog voltage cell or +1 (power supply) for a current cell.

According to a further aspect of the invention, it is proposed that the magnetic sensors are arranged on a circular arc. In this case, the dies are preferably separated by an angle θ in relation to the centre of said circular arc, of: θ=2π/n·p wherein n is a natural number corresponding to the number of pole pairs of the magnetic ring and p is a natural number greater than or equal to 3 corresponding to the number of sensors per pole pair.

For small pitch angles of the pole pairs, e.g. for pitch angles below 10° or below 20°, the circular arc may be sufficiently well approximated by a line such that the magnetic sensors may be placed on a line as well. This may help to reduce the complexity of the manufacturing. Alternatively, the arc-shaped arrangement of the sensors may be achieved by bending a flexible substrate on which the sensor dies are mounted.

In the latter case, n is preferably greater or equal than 3, p is preferably greater or equal than 6 and a radius r of the circular arc is less than 25 mm such that a high angular resolution may be obtained even in small bearings. Six pole pairs may be used e.g. for a 6202 bearing size or smaller.

According to a further aspect of the invention, it is proposed that the magnetic sensors are encapsulated in a material with low temperature resistance.

According to a further aspect of the invention, it is proposed that the magnetic sensors are overmoulded with electrically insulating plastics or polymers of thermoplastic or other type.

According to a further aspect of the invention, it is proposed that the prefabricated package comprises a sealed air capsule.

It is further proposed to provided the sensor arrangement with complementary signal processing electronics integrated in the same prefabricated package. The complementary electronics may include in particular analog signal processing circuits such as substraction circuits.

A further simplification may be obtained, if at least one Analog-to-Digital-Converter (ADC) for processing the signals of the magnetic sensors is integrated in the same prefabricated package.

According to a further aspect of the invention, it is proposed that the prefabricated package comprises one connection for power supply shared by the at least three magnetic sensors.

According to a further aspect of the invention, it is proposed that pins connected to the terminals of the magnetic sensors are integrated with the prefabricated package.

According to a further aspect of the invention, it is proposed that at least one sensor for sensing an entity other than the magnetic field generated by the magnetic ring is integrated in the prefabricated package.

A further aspect of the invention relates to a sensor bearing including an inner ring and an outer ring, a magnetic ring and a sensor arrangement of the above described type. In such a sensor bearing, the magnetic sensors may be arranged so as to face a radially extending pole surface of the magnetic ring. This simplifies the manufacturing of the sensor arrangement since the sensors may be arranged on a flat circuit board arranged parallel to the sensor surface.

Alternatively, the magnetic sensors may be arranged radially outside or inside of a pole surface of the magnetic ring. In this case, the at least three magnetic sensors are preferably arranged with parallel detection surfaces in order to avoid complications in manufacturing. The parallel arrangement of the magnetic sensors results in that the detection surfaces of at least two of the sensors are not arranged orthogonal to the radial direction at their respective centres and thus not orthogonal to the magnetic field at the centres of the poles. Since the Hall sensors are not sensitive to the components of the magnetic field parallel to their detection surfaces, this inclination leads, a priori to a reduction of the signal strength. This reduction in the lateral magnetic sensors may be compensated by arranging the detection surfaces of lateral sensors radial distances to the pole surface of the magnetic ring being smaller than the distance of the centre of the detection surface of at least one central magnetic sensor.

In any case, the magnetic sensors are preferably evenly distributed over the pitch angle of one pole pair of the magnetic ring.

A further aspect of the invention relates to a method for manufacturing a sensor arrangement of the above described type. The method comprises the step of encapsulating the at least three magnetic sensors in a prefabricated package and is characterized by further comprising the step of selecting sensor dies for the at least three magnetic sensors from a single production batch consisting of sensors produced from the same wafer. Dies originating from the same wafer are more uniform than dies originating from different wafers by far. This holds in particular for the thermal behaviour of the sensors. It is known that a particularly detrimental effect may result from so-called “weak points” in a set of sensors. These sensors do not only tend to fail after a short lifetime but further show a notably different thermal behaviour than the other sensors. This leads to a pronounced temperature dependence not only of the signals themselves but in particular of the difference signals. Taking the sensors from the same production batch avoids such weak points and therefore strongly ameliorates the lifetime and temperature operating ability of the sensor arrangement.

The production costs may be reduced because the technology used for manufacturing the sensor arrangements is proven for high volume production, reliable and may be fully automated.

The tolerances of the system may be reduced because a high position accuracy of the individual dies may be achieved by positioning all dies in one single process.

The use of dies issued from the same production batch leads to sensor packages the sensors of which have with very similar sensor characteristics and further increases the accuracy and thermal resistance since weak points are avoided.

Further, by placing all dies in a single package, the dies are exposed to almost the same thermal stress, thus all sensors are equally exposed and the probability to have a “weak point” in the chain may be further reduced.

### 4. BRIEF DESCRIPTION OF THE DRAWINGS

FIG. 1 is a schematic view of a sensor arrangement mounted on a roller bearing,

FIG. 2 is an axial view of a sensor arrangement according to a further embodiment of the invention,

FIG. 3a and FIG. 3b show two possible orientations of the sensor arrangement of the invention,

FIG. 4 is a more detailed view of a sensor package for use in a sensor arrangement according to FIG. 3a,

FIG. 5 is a top view in cut of the sensor package of FIG. 4,

FIG. 6 is a top view of a sensor arrangement according to a further embodiment of the invention,

FIG. 7 is a top view of a sensor arrangement according to a further embodiment of the invention,

FIG. 8—is an axial view of a sensor package for use in a sensor arrangement according to FIG. 3b,

FIG. 8 is an axial view of an alternative sensor package for use in a sensor arrangement according to FIG. 3b,

FIG. 9 shows a solution where the sensors are wired as current cells,

FIG. 10a shows an embodiment of the invention where the sensors are wired as voltage cells,

FIG. 10b shows an embodiment of the invention where the sensors are wired as current cells, and

FIG. 11 shows a further embodiment of the invention with a sensor package including 5 sensors and with complementary electronics integrated with the sensor package.

### 5. DETAILED DESCRIPTION OF THE PREFERRED EMBODIMENTS

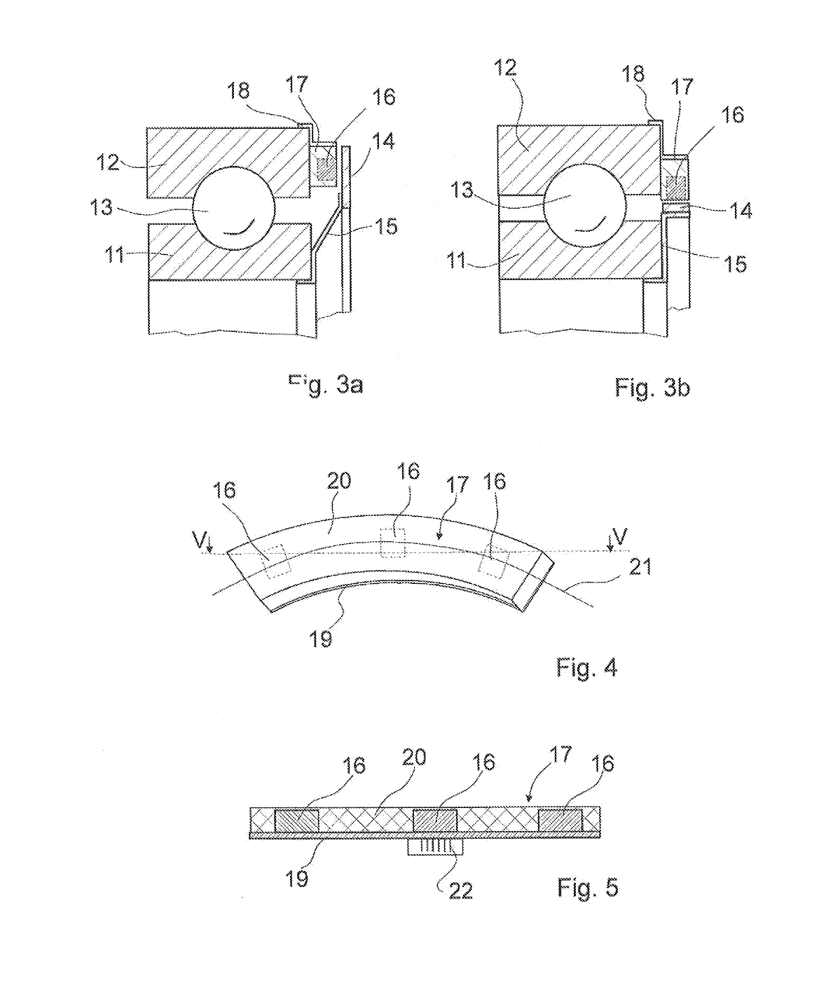

FIG. 1 is a schematic view of a sensor arrangement mounted on a rolling bearing. The rolling bearing 10 comprises an inner ring 11 and an outer ring 12, rolling bodies 13 (FIG. 3a and FIG. 3b) such as balls and a ball bearing retainer (not shown). The bearing is configured for use in applications wherein the outer ring 12 is fixed in a housing, e.g. as a shaft bearing and or for electric motors in hybrid vehicles, starter alternators or the like.

The bearing is a sensor bearing equipped with a sensor arrangement for measuring the relative angular position of the outer ring 12 with respect to the inner ring 11 and vice versa. Since one of the rings 11, 12 is kept fixed, this is equivalent to measuring the absolute position of the respectively other ring. The inner ring 11 is equipped with a magnetic ring 14 with a single or multiple pole pairs. The magnetic ring 14 is coaxially fixed to the inner ring 11, e.g. by means of a snap-fitting engagement of a retainer ring 15 with a pertinent circumferential notch on the inner ring 11. The sensor arrangement further includes at least three magnetic sensors 16, wherein three magnetic sensors 16 are encapsulated in a prefabricated package 17.

The sensors 16 are arranged in such a way that their respective measurement surfaces or active areas are aligned and parallel to the radially extending, ring-shaped pole surface of the magnetic ring 14.

The sensor package 17 may be mounted on the outer ring 12 of the bearing either directly or using a sensor holder with a recess for fitting the sensor package 17 and/or with holes for fixing the sensor package 17 with screws.

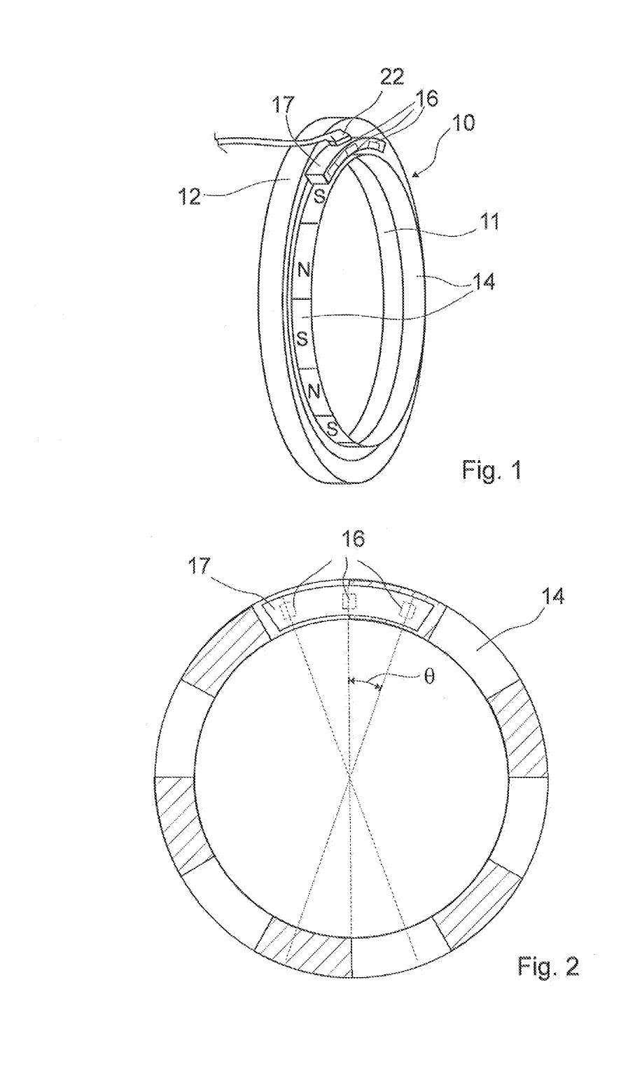

FIG. 2 shows an axial view of a sensor arrangement according to a further embodiment of the invention. The sensors 16 in FIG. 2 are oriented axially, whereas the sensors 16 in the sensor package 17 of FIG. 1 are oriented radially inward. The angular space between the sensors 16 as well as the pole pitch of the magnetic ring 14 are identical.

The sensor dies 16 are equidistantly separated by an angle θ in relation to the centre of the circular arc, of:

$$θ = \frac{2 π}{n \cdot p}$$

wherein n is a natural number corresponding to the number of pole pairs of the magnetic ring 14 and p is a natural number greater than or equal to 3 corresponding to the number of sensors 16 per pole pair. In the illustrated embodiment, n equals 6 and p equals 3 and the radius r of the circular arc is around 20 mm. This corresponds to θ=20°. It has been proven that multi-polar sensors 16 are more precise when all the sensing elements are located within the angle of one magnetic pole pair (compared to circumferential location).

FIGS. 3a and 3b show alternatives for the orientation of the sensors 16 and of the magnetic ring 14. In the embodiment of FIG. 3a, which corresponds to the arrangement of FIG. 2, the pole surface of the magnetic ring 14 as well as the active areas of the sensors 16 are oriented axially and a small axial gap is formed between the pole surface and the sensor package 17. In the embodiment of FIG. 3b, which corresponds to the arrangement of FIG. 1, the pole surface of the magnetic ring 14 as well as the active areas of the sensors 16 are oriented radially and a small radial gap is formed between the pole surface and the sensor package 17.

In both cases, the sensor package 17 is fixed by means of a sensor holder 18 to the outer ring 12 of the bearing and the magnetic ring 14 is fixed by means of the retainer ring 15 to the inner ring 11 of the bearing. This arrangement may, of course, be inversed if e.g. the bearing shall be mounted in such a way that the inner ring 11 is kept fixed and the outer ring 12 is rotating.

FIG. 4 is a more detailed view of the prefabricated package 17 with the magnetic sensors 16 of a sensor arrangement for use in the orientation of FIG. 3a. The sensors 16 are mounted on a printed circuit board 19 and potted with an insulating material 20 such as plastics (FIG. 5) such that the outer shape of the sensor package 17 basically corresponds to an arcuate cuboid. In the illustrated embodiment, the magnetic sensors 16 are Hall sensors more specifically analog linear Hall dies. However, alternative embodiments could employ GMR sensors 16 for similar purposes.

The magnetic sensors 16 are arranged on a curve 21 having the shape of a circular arc. The curve 21 is concentric with the rotation centre of the bearing and with the centre of the magnetic ring 14. The sensors 16 are aligned with tangents to the curve 21 at their respective centres such that the edges of the active areas of the magnetic sensors 16 are not parallel to each other.

FIG. 5 shows a cut along the line V-V of FIG. 4. The naked semiconductor chips constituting the Hall dies 16 are directly mounted on a printed circuit board 19 using the chip-on-board technology and potted or overmoulded with an insulating plastics material 20 afterwards. The plastics material 20 used for potting the sensor arrangement is chosen from materials with low temperature resistance. This ensures a uniform temperature of the sensors 16 such that temperature variations affect each of the sensors 16 in a similar way and may be compensated e.g. by calculating differences between the signals. A thermal insulation of the sensors 16 may be achieved in alternative embodiments where the prefabricated package 17 comprises a sealed air capsule.

Pins connected to the terminals of the magnetic sensors 16 are integrated with the prefabricated package 17 in a simple pins layout such that the sensors 16 can be connected to a read-out electronics by means of a single plug connector 22 on the back of the sensor package 17. The connection between the dies and the pins may be established by printed lines on the circuit board 19 and/or the dies may be directly bonded to the pins. The package 17 comprises one connection for power supply. This connection is shared by the at least three magnetic sensors 16.

The sensor arrangement described above is fabricated by encapsulating the at least three magnetic sensors 16 in a prefabricated package 17. The sensors 16 dies used in one sensor package 17 are selected from a single production batch consisting of sensors 16 produced from the same wafer. This ensures that the dies are to a very high degree similar to each other and show only very small variations in their characteristics.

With the above-described technology, very small sensor arrangements can be obtained. This simplifies the provision of small bearings with precise multipolar sensor functions. 6 pair poles or more may be used e.g. in a 6202 bearing size. Further, sensor-bearings with a large number of pair poles and thus with a high angular resolution may be obtained while respecting the performance design rule that all the sensing elements are located within the angle of one magnetic pole pair.

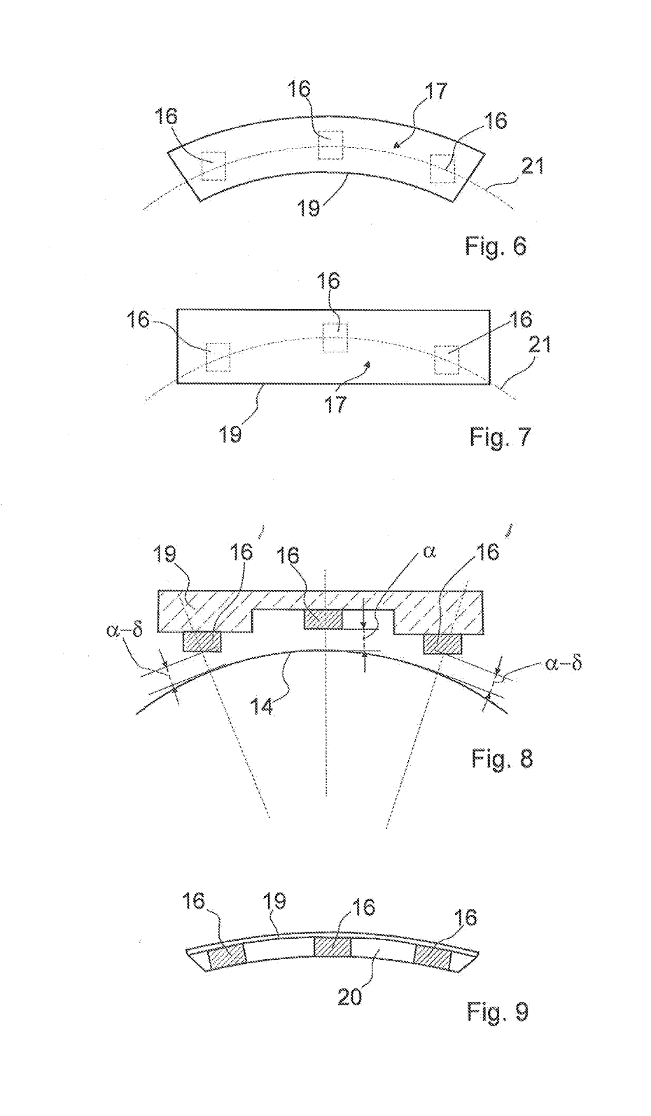

FIG. 6 is a top view or axial view of a sensor arrangement according to a further embodiment of the invention. Just as in the embodiment of FIG. 4, the magnetic sensors 16 are arranged on a curve 21 having the shape of a circular arc. The curve 21 is concentric with the rotation centre of the bearing and with the centre of the magnetic ring 14. However, in contrast to the embodiment of FIG. 4, the sensors 16 are not aligned with tangents to the curve 21 at their respective centres but are arranged in such a way that the edges of the active areas of the Hall sensors 16 are parallel to each other.

In the embodiments of FIGS. 4-6, the curvature or the arcuate shape of the sensor package 17 may be obtained either by using a circuit board 19 with the shape of a ring section and by bonding the sensor dies on the curved circuit board 19 or by bonding the sensor dies 16 onto a rectangular circuit board 19 and cutting out the curved shape afterwards. For smaller curvatures, flexible circuit boards of a rectangular shape may be used, which may be bent before potting or upon mounting the package 17 onto the bearing.

FIG. 7 is a schematic representation of yet an alternative sensor arrangement, wherein a rectangular circuit board 19 is used for further simplifying the manufacturing of the sensor package 17.

FIG. 8 is a schematic representation of an alternative sensor arrangement with radially oriented magnetic sensors 16, 16′ according to a third embodiment of the invention. In this embodiment, the magnetic sensors 16, 16′ are arranged radially outside or inside of a pole surface of the magnetic ring 14, wherein the at least three magnetic sensors 16 are arranged with parallel detection surfaces. The centres of the detection surfaces of lateral sensors 16′ are arranged at a smaller radial distance α−δ to the pole surface of the magnetic ring 14 than the centre of the detection surface of at least one central magnetic sensor 16 at a distance α in order to compensate for the tilting angle of the active area with respect to the roughly radial field lines. The difference δ may then be chosen such that the signal amplitudes delivered by the three sensors 16 when the magnetic ring 14 is rotating are equal.

The difference δ may be set by suitably choosing the height of a step in a stepped substrate 19 onto which the sensors 16 are mounted.

FIG. 9 is a schematic representation of an alternative sensor arrangement with radially oriented magnetic sensors 16 according to a fourth embodiment of the invention. This embodiment uses a bent substrate 19 instead of a stepped substrate in order to facilitate the manufacturing. The substrate 19 may be bent upon encapsulating the package 17 such that the encapsulation material fixes the shape of the package 17 upon curing or, alternatively, both the circuit board 19 and the potting material may be chosen such that the entire package 17 is flexible. The curvature may then be introduced upon mounting the package 17 onto the ring 11, 12 of the bearing. The flexibility of the package 17 may enable the use of the same sensor arrangement in connection with bearings and/or magnetic rings 14 of different curvatures. The final curvature may be fixed upon mounting the sensor package 17 onto the inner or outer ring 12 of the bearing.

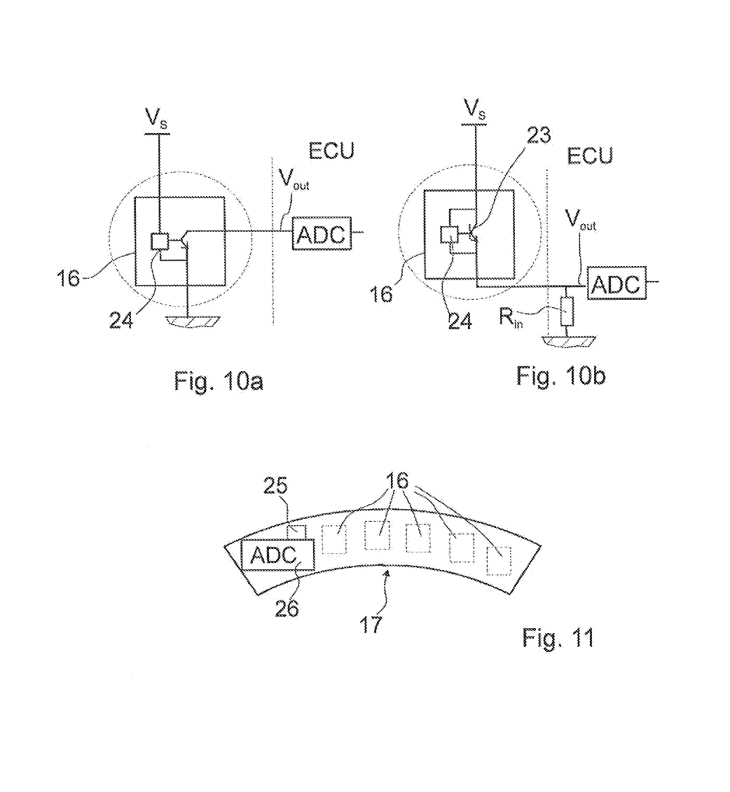

FIGS. 10a and 10b show different possible wirings of Hall dies. FIG. 10b shows a solution where the sensors 16 are wired as current cells and FIG. 10a shows a solution where the sensors 16 are wired as voltage cells. The Pin number of the total package 17 is equal to the number of dies+2 (power supply and ground) for an analog voltage cell according to FIG. 10a or equal to the number of dies+1 (power supply) for a current cell according to FIG. 10b. In FIGS. 10a and 10b, Vs refers to the source voltage and Vout refers to the output voltage inputted to an analog-to-digital converter ADC provided in an engine control unit ECU reading out the sensors 16. In FIG. 10b, Rin is a resistance used for converting the field-dependent current passing through the transistor 23 of the sensor 16. The active areas 24 of the sensors 16 are illustrated as rectangles in FIGS. 10a and 10b.

Further possible embodiments of the invention as shown in FIG. 11 include sensor packages 17 wherein at least one sensor 25 for sensing an entity other than the magnetic field generated by the magnetic ring 14 is integrated in the prefabricated package 17. This sensor 25 may e.g. be a temperature sensor or a position sensor. The sensor package 17 may further comprise complementary signal processing electronics 26 integrated in the same prefabricated package 17 and/or more than 3 magnetic sensors 16. In the embodiment of FIG. 11, an analog-to-digital-converter for processing the signals of the magnetic sensors 16 is integrated in the same prefabricated package 17.

The above embodiments of the invention as well as the appended claims and figures show multiple characterizing features of the invention in specific combinations. The skilled person will easily be able to consider further combinations or sub-combinations of these features in order to adapt the invention as defined in the claims to his specific needs.

1. A sensor arrangement for use in a sensor bearing with a magnetic ring with single or multiple pole pairs, the sensor arrangement including at least three magnetic sensors, wherein the at least three magnetic sensors are encapsulated in a prefabricated package.

2. The sensor arrangement according to claim 1, wherein the at least three magnetic sensors are Hall sensors.

3. The sensor arrangement according to claim 1, wherein the Hall sensors are analog linear Hall dies.

4. The sensor arrangement according to claim 1, wherein naked semiconductor chips constituting the magnetic sensors are directly mounted on a printed circuit board using the chip-on-board technology.

5. The sensor arrangement according to claim 1, wherein the magnetic sensors are arranged on a circular arc.

6. The sensor arrangement according to claim 5, wherein the dies are separated by an angle θ in relation to the centre of said circular arc, of:
$$θ = \frac{2 π}{n \cdot p}$$
wherein n is a natural number corresponding to the number of pole pairs of the magnetic ring and p is a natural number greater than or equal to 3 corresponding to the number of sensors per pole pair.

7. The sensor arrangement according to claim 6, wherein n is greater or equal than 3, p is greater or equal than 6 and a radius r of the circular arc is less than 25 mm.

8. The sensor arrangement according to claim 1, wherein the magnetic sensors are encapsulated in a material with low temperature resistance.

9. The sensor arrangement according to claim 1, further comprising complementary signal processing electronics integrated in the same prefabricated package.

10. The sensor arrangement according to claim 1, wherein the prefabricated package comprises a single connection for power supply shared by the at least three magnetic sensors.

11. The sensor arrangement according to claim 1, wherein at least one sensor for sensing an entity other than the magnetic field generated by the magnetic ring is integrated in the prefabricated package.

12. A sensor bearing including an inner ring and an outer ring, a magnetic ring and a sensor arrangement including at least three magnetic sensors encapsulated in a prefabricated package.

13. The sensor bearing according to claim 12, wherein the magnetic sensors are arranged so as to face a radially extending pole surface of the magnetic ring.

14. The sensor bearing according to claim 12, wherein the magnetic sensors are arranged radially outside or inside of a pole surface of the magnetic ring, wherein the at least three magnetic sensors are arranged with parallel active areas, wherein centres of the active areas of lateral sensors are arranged at a smaller radial distance to the pole surface of the magnetic ring than the centre of the detection surface of at least one central magnetic sensor.

15. A method for manufacturing a sensor arrangement including at least three magnetic sensors, the method comprising the steps of:
encapsulating the at least three magnetic sensors in a prefabricated package, and
selecting sensor dies for the at least three magnetic sensors from a single production batch consisting of sensors produced from a same wafer.
